(19) United States
(12) Patent Application Publication
(10) Pub. No.: US 2011/0222276 A1
(43) Pub. Date: Sep. 15, 2011

(54) ILLUMINATING DEVICE AND ILLUMINATING UNIT INCLUDING A PLURALITY OF THE SAME ILLUMINATING DEVICES

(75) Inventor: Yasunobu Kasuya, Tokyo (JP)

(73) Assignee: NEC Lighting, Ltd., Tokyo (JP)

(21) Appl. No.: 12/673,487

(22) PCT Filed: Jul. 4, 2008
(86) PCT No.: PCT/JP2008/062181

§ 371 Date: Feb. 12, 2010

(30) Foreign Application Priority Data
Aug. 9, 2007 (JP) 2007-208158

(51) Int. Cl. F21S 4/00; F21V 21/00

(52) U.S. Cl. 362/225; 362/217.14

(57) ABSTRACT

In an illuminating device that includes a cold cathode fluorescent lamp, and a device main body on which the cold cathode fluorescent lamp is disposed, cable connectors to which a power supply cable for supplying an electric power to the illuminating device is connected are provided on a first side surface of the device main body and a second side surface that is opposite to the first side surface.

### TECHNICAL FIELD

The present invention relates to an illuminating device including a cold cathode fluorescent lamp and an illuminating unit including a plurality of the illuminating devices.

### BACKGROUND ART

A cold cathode fluorescent lamp (CCFL) starts discharge using an initial electron existing therein and starts lighting as a result of the discharge. The cold cathode fluorescent lamp advantageously has a smaller tube diameter and a longer lifetime than a hot cathode fluorescent lamp conventionally widely used. Specifically, the cold cathode fluorescent lamp has a tube diameter of 1.8 to 5.0 mm and a lifetime of about 40000 to 60000 hours. Because of the advantages described above, the cold cathode fluorescent lamp has been used as a light source of a backlight. However, at present, application of the cold cathode fluorescent lamp to ordinary illuminating devices is being pursued.

Japanese Patent Laid-Open NO. 2007-66628 (referred to as patent literature 1 hereinafter) discloses an illuminating device that uses the cold cathode fluorescent lamp. The illuminating device shown in FIG. 5 of the patent literature 1 is to be installed on a ceiling or the like and includes two cold cathode fluorescent lamps disposed in parallel with each other.

As described above, the cold cathode fluorescent lamp advantageously has a smaller tube diameter and a longer lifetime than the hot cathode fluorescent lamp. Therefore, the illuminating device using the cold cathode fluorescent lamp has advantages in which the installation space is small, and the number of times that the lamp needs to be replaced decreases.

Because of the advantages described above, the illuminating device using the cold cathode fluorescent lamp is suitable for installation on a wall, for example. In this case, a plurality of illuminating devices is vertically and horizontally installed on a wall, and a translucent panel member of a white color, for example, is installed in front of the illuminating devices. Since the installation space of the illuminating device using the cold cathode fluorescent lamp is small, the illuminating device does not require a great depth for installation. The translucent panel member is illuminated by the plurality of illuminating devices installed at the back thereof and shines over the entire surface. If the panel member is installed to cover substantially the entire wall surface, the entire wall surface shines, so that a room atmosphere that cannot be produced with the ordinary illumination can be provided. In addition, the illuminating devices installed on the wall surface can be used also to illuminate an advertising panel or the like installed on the wall surface.

Now, problems with a related art will be described.

FIG. 4 is a schematic front view showing a plurality of illuminating devices including a cold cathode fluorescent lamp according to the related art arranged in the longitudinal direction (a longitudinal arrangement). FIG. 5 is a schematic front view showing a plurality of illuminating devices including a cold cathode fluorescent lamp according to the related art arranged in a direction perpendicular to the longitudinal direction (a lateral arrangement).

In the case where a plurality of illuminating devices are arranged in the longitudinal arrangement as shown in FIG. 4, the illuminating devices are supplied with electric power through power supply cables 103 connecting the illuminating devices to each other. However, if each illuminating device includes cable connectors 101a on one side thereof, power supply cables 103 are arranged on only one side of the illuminating devices. That is, power supply cables 103 are concentratedly arranged on one side.

In the case where a plurality of illuminating devices are arranged in the lateral arrangement as shown in FIG. 5, again, the illuminating devices are supplied with electric power through power supply cables 103 connecting the illuminating devices to each other. In the case of this arrangement, if each illuminating device includes cable connectors 101a on one side thereof, power supply cables 103 connecting vertically adjacent illuminating devices have to be routed to detour around the illuminating devices. As a result, the flexibility of placement or flexibility to route power supply cables 103 decreases, and the arrangement of power supply cables 103 is complicated.

### DISCLOSURE OF THE INVENTION

An object of the present invention is to provide an illuminating device and an illuminating unit including a plurality of the illuminating devices that can solve at least one of the problems in the related art described above. An example of this object is to simplify the arrangement of power supply cables that connect a plurality of illuminating devices installed side by side to each other.

According to an aspect of the present invention, there is provided an illuminating device comprising a cold cathode fluorescent lamp, and a device main body on which the cold cathode fluorescent lamp is disposed. In this illuminating device, cable connectors to which a power supply cable for supplying an electric power to the illuminating device is connected are provided on a first side surface of the device main body and a second side surface that is opposite to the first side surface.

According to another aspect of the present invention, there is provided an illuminating unit that includes a plurality of illuminating devices according to the aspect described above arranged in a longitudinal direction of the illuminating devices. In this illuminating unit, a connection between the cable connectors on the first side surface of two adjacent illuminating devices via the power supply cable and a connection between the cable connectors on the second side surface of two adjacent illuminating devices via the power supply cable occur alternately.

According to another aspect of the present invention, there is provided an illuminating unit that includes a plurality of illuminating devices according to the aspect described above arranged in a direction perpendicular to a longitudinal direction of the illuminating devices. In this illuminating unit, the cable connectors on two adjacent illuminating devices that are opposite to each other are connected by the power supply cable.

### BRIEF DESCRIPTION OF THE DRAWINGS

FIG. 1 is a schematic diagram showing an illuminating device according to an exemplary embodiment of the present invention;

FIG. 2 is a schematic front view showing an illuminating unit of a longitudinal arrangement in which illuminating devices according to the exemplary embodiment shown in FIG. 1 are arranged in the longitudinal direction;

FIG. 3 is a schematic front view showing an illuminating unit of a lateral arrangement in which illuminating devices according to the exemplary embodiment shown in FIG. 1 are arranged in the direction perpendicular to the longitudinal direction;

FIG. 4 is a schematic front view showing a plurality of illuminating devices including a cold cathode fluorescent lamp according to the related art arranged in the longitudinal direction (a longitudinal arrangement); and

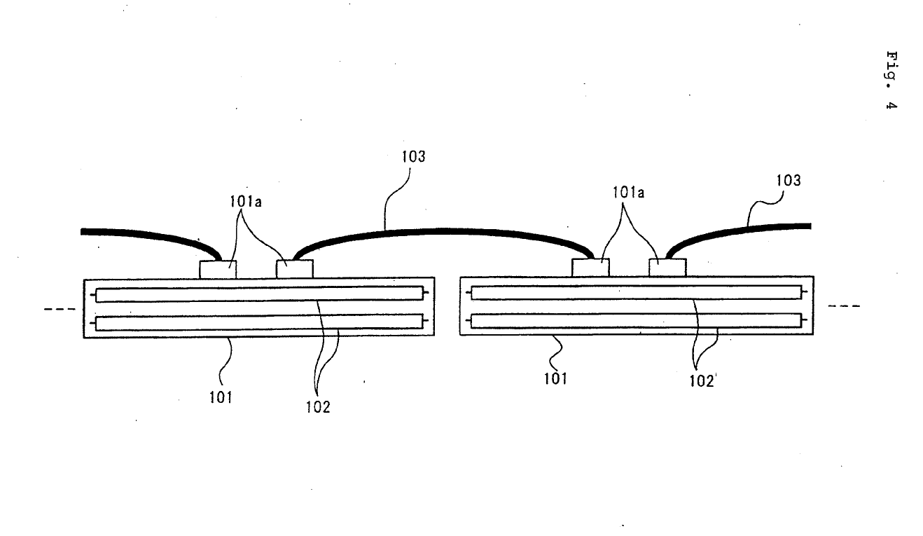

FIG. 5 is a schematic front view showing a plurality of illuminating devices including a cold cathode fluorescent lamp according to the related art arranged in the direction perpendicular to the longitudinal direction (a lateral arrangement).

### BEST MODE FOR CARRYING OUT THE INVENTION

In the following, an exemplary embodiment of the present invention will be described with reference to the drawings.

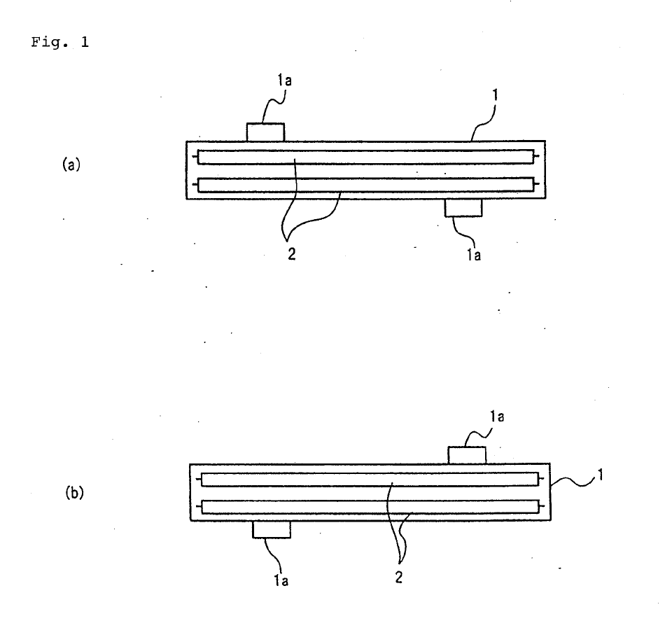

FIG. 1 includes schematic diagrams showing illuminating devices according to an exemplary embodiment of the present invention. FIG. 1(a) is a plan view showing an illuminating device according to a first aspect of this exemplary embodiment, and FIG. 1(b) is a plan view showing an illuminating device according to a second aspect of this exemplary embodiment.

As shown in FIGS. 1(a) and 1(b), the illuminating devices according to this exemplary embodiment have device main body 1, and a plurality of cold cathode fluorescent lamps (CCFL) 2 attached to device main body 1. Cold cathode fluorescent lamps 2 each have a bulb made of glass that has a tubular shape.

A phosphor film is formed on an inner surface of the bulb. An inert gas, such as argon (Ar) and neon (Ne), and mercury (Hg) are sealed in the bulb. The bulb is provided with cold cathode electrodes on the opposite ends. The cold cathode electrodes are connected to a lighting circuit (not shown) disposed in device main body 1 via a wiring (not shown).

The illuminating devices according to this exemplary embodiment further include one cable connector 1a, to which a power supply cable is connected, on each of two longitudinal side surfaces of device main body 1. In the first aspect shown in FIG. 1(a), furthermore, one of cable connectors 1a that is disposed on the upper side surface in this drawing is disposed closer to the left end of device main body 1 in the longitudinal direction in this drawing, and the other of the cable connectors 1a that is disposed on the lower side surface in this drawing is disposed closer to the right end of device main body 1 in the longitudinal direction in this drawing.

On the other hand, in the second aspect shown in FIG. 1(b), one of cable connectors 1a that is disposed on the upper side surface in this drawing is disposed closer to the right end of device main body 1 in the longitudinal direction in this drawing, and the other of the cable connectors 1a that is disposed on the lower side surface in this drawing is disposed closer to the left end of device main body 1 in the longitudinal direction in this drawing.

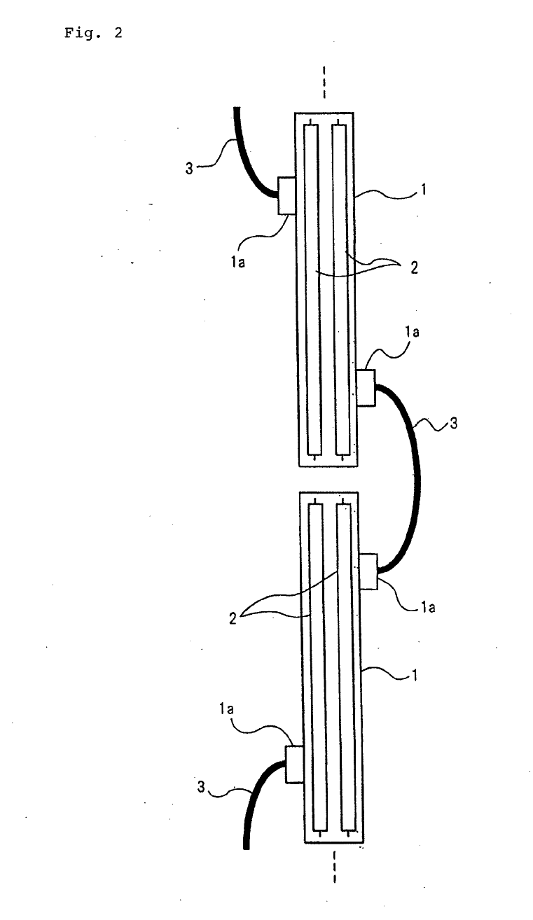

FIG. 2 is a schematic front view showing an illuminating unit of a longitudinal arrangement in which illuminating devices according to this exemplary embodiment shown in FIG. 1 are arranged in the longitudinal direction.

In FIG. 2, the illuminating device according to the first aspect shown in FIG. 1(a) and the illuminating device according to the second aspect shown in FIG. 1(b) are alternately disposed. As described above, the illuminating devices according to this exemplary embodiment each have one cable connector 1a on each of two longitudinal side surfaces of device main body 1.

Therefore, if cable connectors 1a disposed on the side surfaces on the same side of two adjacent illuminating devices are connected to each other by power supply cable 3, power supply cables 3 are arranged alternately on the opposite sides of the illuminating devices in a distributed manner. Thus, power supply cables 3 are not concentrated on one side of the illuminating devices.

Furthermore, if the illuminating device according to the first aspect and the illuminating device according to the second aspect are alternately arranged as shown in FIG. 2, cable connectors 1a of two adjacent illuminating devices are located near the facing ends of the illuminating devices. Therefore, the length of power supply cables 3 that connect cable connectors 1a to each other can be shortened, and the cost of and the space occupied by power supply cables 3 can be reduced accordingly.

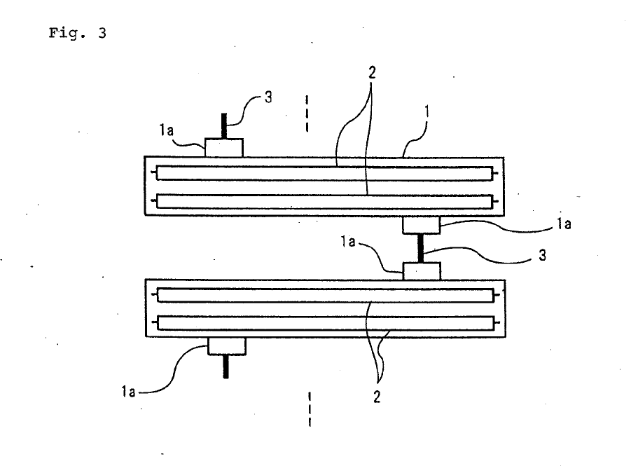

FIG. 3 is a schematic front view showing an illuminating unit of a lateral arrangement in which illuminating devices according to this exemplary embodiment shown in FIG. 1 are arranged in the direction perpendicular to the longitudinal direction. In FIG. 3 also, the illuminating device according to the first aspect shown in FIG. 1(a) and the illuminating device according to the second aspect shown in FIG. 1(b) are alternately disposed.

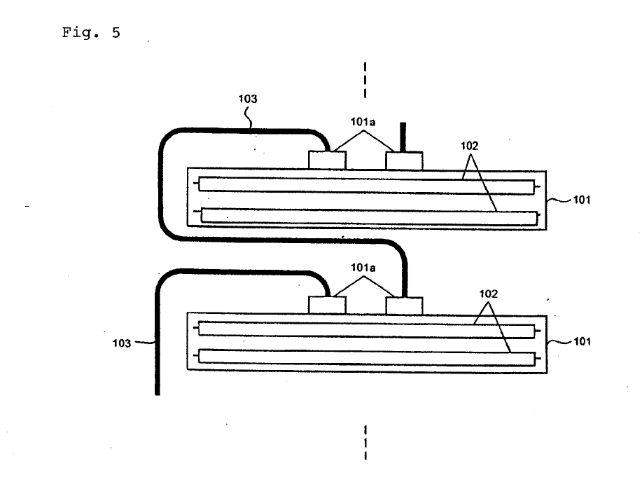

As described above, the illuminating devices according to this exemplary embodiment include one cable connector 1a on each of two longitudinal side surfaces of device main body 1. Therefore, in the lateral arrangement shown in FIG. 3, cable connectors 1a on the opposite side surfaces of two adjacent illuminating devices can be connected to each other by power supply cable 3. Therefore, two adjacent illuminating devices can be connected to each other without routing a plurality of power supply cables 3 to detour the illuminating devices as shown in FIG. 5.

Furthermore, in the case where the illuminating device according to the first aspect and the illuminating device according to the second aspect are alternately arranged as shown in FIG. 3, cable connectors 1a on two adjacent illuminating devices are opposite to each other. Therefore, the length of power supply cables 3 that connect cable connectors 1a to each other can be shortened, and the cost of and the space occupied by power supply cables 3 can be reduced accordingly.

With the arrangements according to the exemplary embodiment described above, when a plurality of illuminating devices are arranged side by side and connected to each other by a power supply cable, wiring of the power supply cable can be simplified.

The present invention has been described with reference to an exemplary embodiment thereof. However, the present invention is not limited to the exemplary embodiment described above. Various modifications to the configurations or details of the present invention will occur to those skilled in the art, and such various modifications can be made without departing from the scope and spirit of the present invention.

This application claims priority of Japanese Patent Application No. 2007-208158, which is filed on Aug. 9, 2007, and incorporates the entire disclosure thereof.

1-7. (canceled)

8. An illuminating device, comprising:
a cold cathode fluorescent lamp; and
a device main body on which the cold cathode fluorescent lamp is disposed,
wherein cable connectors to which a power supply cable for supplying an electric power to the illuminating device is connected are provided on a first side surface of the device main body and on a second side surface that is opposite to the first side surface.

9. The illuminating device according to claim 8, wherein said cable connector provided on said first side surface is disposed closer to a first longitudinal end of said device main body, and said cable connector provided on said second side surface is disposed closer to a second longitudinal end of said device main body that is opposite to said first end.

10. The illuminating device according to claim 8, wherein said cable connector provided on said second side surface is disposed closer to a first longitudinal end of said device main body, and said cable connector provided on said first side surface is disposed closer to a second longitudinal end of said device main body that is opposite to said first end.

11. An illuminating unit that includes a plurality of illuminating devices according to claim 8 arranged in a longitudinal direction of said illuminating devices,
wherein a connection between the cable connectors on said first side surface of two adjacent illuminating devices via said power supply cable and a connection between the cable connectors on said second side surface of two adjacent illuminating devices via said power supply cable occur alternately.

12. An illuminating unit that includes a plurality of illuminating devices according to claim 8 arranged in a direction perpendicular to a longitudinal direction of said illuminating devices,
wherein the cable connectors on two adjacent illuminating devices that are opposite to each other are connected by said power supply cable.

13. An illuminating unit that includes a plurality of illuminating devices of a first type and a plurality of illuminating devices of a second type that are alternately arranged in a longitudinal direction of said illuminating devices,
wherein each said illuminating devices of the first type is the illuminating device according to claim 8, wherein said cable connector provided on said first side surface is disposed closer to a first longitudinal end of said device main body, and said cable connector provided on said second side surface is disposed closer to a second longitudinal end of said device main body that is opposite to said first end,
wherein each said illuminating devices of the second type is the illuminating device according to claim 8, wherein said cable connector provided on said second side surface is disposed closer to a first longitudinal end of said device main body, and said cable connector provided on said first side surface is disposed closer to a second longitudinal end of said device main body that is opposite to said first end, and
wherein a connection between the cable connectors on said first side surface of two adjacent illuminating devices via said power supply cable and a connection between the cable connectors on said second side surface of two adjacent illuminating devices via said power supply cable occur alternately.

14. An illuminating unit that includes a plurality of illuminating devices of a first type and a plurality of illuminating devices of a second type that are alternately arranged in a direction perpendicular to a longitudinal direction of said illuminating devices,
wherein each said illuminating devices of the first type is the illuminating device according to claim 8, wherein said cable connector provided on said first side surface is disposed closer to a first longitudinal end of said device main body, and said cable connector provided on said second side surface is disposed closer to a second longitudinal end of said device main body that is opposite to said first end,
wherein each said illuminating devices of the second type is the illuminating device according to claim 8, wherein said cable connector provided on said second side surface is disposed closer to a first longitudinal end of said device main body, and said cable connector provided on said first side surface is disposed closer to a second longitudinal end of said device main body that is opposite to said first end, and
wherein the cable connectors on two adjacent illuminating devices that are opposite to each other are connected by said power supply cable.

15. An illuminating unit that includes a plurality of illuminating devices according to claim 9 arranged in a longitudinal direction of said illuminating devices,
wherein a connection between the cable connectors on said first side surface of two adjacent illuminating devices via said power supply cable and a connection between the cable connectors on said second side surface of two adjacent illuminating devices via said power supply cable occur alternately.

16. An illuminating unit that includes a plurality of illuminating devices according to claim 10 arranged in a longitudinal direction of said illuminating devices,
wherein a connection between the cable connectors on said first side surface of two adjacent illuminating devices via said power supply cable and a connection between the cable connectors on said second side surface of two adjacent illuminating devices via said power supply cable occur alternately.

17. An illuminating unit that includes a plurality of illuminating devices according to claim 9 arranged in a direction perpendicular to a longitudinal direction of said illuminating devices,
wherein the cable connectors on two adjacent illuminating devices that are opposite to each other are connected by said power supply cable.

18. An illuminating unit that includes a plurality of illuminating devices according to claim 10 arranged in a direction perpendicular to a longitudinal direction of said illuminating devices,
wherein the cable connectors on two adjacent illuminating devices that are opposite to each other are connected by said power supply cable.
